(19) United States
(12) Patent Application Publication
(10) Pub. No.: US 2022/0012806 A1
(43) Pub. Date: Jan. 13, 2022

(54) ELECTRICITY MARKET TRADING AND EVALUATION METHOD BASED ON WEAK CENTRALIZED CONSORTIUM BLOCKCHAIN

(71) Applicants: State Grid ZheJiang HangZhou XiaoShan Power Supply Company, Hangzhou (CN); ZheJiang ZhongXin Power Engineering Construction Co., Ltd., Hangzhou (CN); State Grid ZheJiang HangZhou Power Supply Company, Hangzhou (CN)

(72) Inventors: Weifeng Xu, Hangzhou (CN); Zhijun Liu, Hangzhou (CN); Wei Chen, Hangzhou (CN); Bin Yu, Hangzhou (CN); Liguo Weng, Hangzhou (CN); Hua Fan, Hangzhou (CN); Xinglong Feng, Hangzhou (CN); Jie Chen, Hangzhou (CN); Yaowen Wei, Hangzhou (CN); Kailong Huo, Hangzhou (CN); Yanghui Zhang, Hangzhou (CN)

(21) Appl. No.: 17/226,039

(22) Filed: Apr. 8, 2021

Related U.S. Application Data
(63) Continuation-in-part of application No. PCT/CN2020/140395, filed on Dec. 28, 2020.

(30) Foreign Application Priority Data
Jul. 10, 2020 (CN) 202010661634.7

(51) Int. Cl. G06Q 40/04; G06Q 50/06; H04L 9/06

(52) U.S. Cl. CPC G06Q 40/04; H04L 2209/38; H04L 9/0618; G06Q 50/06

(57) ABSTRACT

The present disclosure relates to energy trading blockchain technology, and specifically to an electricity market trading and evaluation method based on a weak centralized consortium blockchain. Through the consortium blockchain, a peer-to-peer (P2P) network, and a delegated byzantine fault tolerance consensus mechanism, electricity market operating organizations and electricity market trading entities are classified into a full-node network and a light-node network respectively; central control authority of the market operating organization is partially liberated by introducing the consortium blockchain technology and using a weak centralization characteristic thereof; the underlying P2P network of the architecture satisfies the exchange of resources and services between various market entities, and adapts to the distribution characteristics of the electricity trading market; based on the byzantine fault tolerance consensus communication technology, invulnerability and survivability indicators are established, and the reliability of the weak centralized blockchain technology in the electricity trading market is measured quantitatively.

### CROSS-REFERENCE TO RELATED APPLICATIONS

The present application is a Continuation-In-Part Application of PCT application No. PCT/CN2020/140395 filed on Dec. 28, 2020, which claims the benefit of Chinese Patent Application No. 202010661634.7 filed on Jul. 10, 2020, the contents of which are hereby incorporated by reference.

### TECHNICAL FIELD

The present disclosure relates to the technical field of energy trading blockchain, and in particular, to an electricity market trading and evaluation method based on a weak centralized consortium blockchain.

### BACKGROUND

With the gradual liberalization of the electricity sales market and the increasing number of trading entities, a large amount of diversified trading data has been generated. The management of an electricity information system has become more difficult, and a distributed electricity trading platform is required to be more efficient and reliable. As an emerging distributed value transfer protocol, the blockchain technology has the technical characteristic of weak centralization, which helps electricity market trading entities to give full play to market-oriented autonomous behaviors, thus promoting fair, just and efficient operation of electricity market trading. Therefore, the blockchain technology is widely used in the field of electricity trading.

Yang Dechang et al. analyzed the compatibility of the blockchain and energy Internet as well as the application prospects of the blockchain technology in electricity system reform in Developing Status and Prospect Analysis of Blockchain in Energy Internet. Ouyang Xu et al. established the access mechanism and trading framework of the blockchain technology for direct purchase of electricity by big consumers in Preliminary Applications of Blockchain Technique in Large Consumers Direct Power Trading. In Analysis and Recommendations of Typical Market-based Distributed Generation Trading Mechanisms, Lin Li et al. optimized different electricity trading mechanism strategies based on the blockchain technology, and further analyzed the characteristics of typical energy blockchain projects abroad. She Wei et al. combined the blockchain technology with a virtual power plant operation scheduling model in Virtual Power Plant Operation and Scheduling Model Based on Energy Blockchain Network, and were committed to improving operation efficiency of a virtual power plant as well as data and storage security. In Distributed Energy Transaction Mechanism Design Based on Smart Contract, Yu S, Yang S et al. implemented the electricity market trading mechanism based on the blockchain smart contract, and analyzed the auditing, bidding, clearing and settlement process in the electricity trading process.

The current electricity trading model is gradually evolving from centralized to distributed, leading to hidden problems such as insufficient mutual trust among market entities, low data security, and difficult management under the distributed electricity trading model. The traditional centralized electricity trading model in which power grid companies supply power to users vertically can hardly meet the requirements of distributed electricity trading, and the reliability is greatly reduced. Therefore, the electricity market urgently needs to use the blockchain technology to make the electricity market trading mode weakly centralized.

### SUMMARY

The objective of the present disclosure is to provide a method that partially liberates central control authority of a power grid by a weak centralization characteristic of a blockchain technology, to realize flexible, autonomous, fair and just trading of electricity, while the method is capable of accommodating a large amount of trading data generated by distributed electricity trading.

In order to achieve the foregoing purpose, the present disclosure adopts the following technical solution: an electricity market trading method based on a weak centralized consortium blockchain, where through the consortium blockchain, a P2P network, and a delegated byzantine fault tolerance consensus mechanism, electricity market operating organizations and electricity market trading entities are classified into a full-node network and a light-node network respectively; the electricity market operating organizations are equivalent to full nodes, where the full nodes store all structured contract basic data and trading data starting from a genesis block, and protect user privacy and confidential information of trading through hash mapping.

The electricity market trading entities act as light nodes in a consortium blockchain energy trading network, and participate in an electricity trading process through a certain access mechanism; the light nodes, which are scalable and account for a major node proportion, are used to save contract-related trading hash values and trading data with adjacent timestamps that is necessary for brief payment verification, and can upload and download data from the full nodes.

In the foregoing electricity market trading method based on a weak centralized consortium blockchain, consensus nodes of the consortium blockchain energy trading network are responsible for permission control and bookkeeping, while offline rules restrict behaviors of participants.

In the foregoing electricity market trading method based on a weak centralized consortium blockchain, the peer-to-peer (P2P) network is introduced in a bottom layer of a communication architecture of the consortium blockchain energy trading network, while a central server of a conventional client/server (C/S) mode is removed; and central processing unit (CPU) computing resource sharing, disk storage sharing and information exchange are realized among nodes of the P2P network.

In the foregoing electricity market trading method based on a weak centralized consortium blockchain, electricity market operating organizations include an electricity trading center and an electricity scheduling organization; the electricity market trading entities include a power generation plant, an electricity retailer, a power grid enterprise, an electricity user, and an independent auxiliary service provider.

In the foregoing electricity market trading method based on a weak centralized consortium blockchain, the access mechanism of the electricity market trading entity includes: the electricity market trading entity submits an identity (ID), a geographic location, an energy type, and electricity generation feature information to the electricity trading center, and the ID, the geographic location, the energy type, and the electricity generation feature information are broadcast to the entire network through the consortium blockchain energy trading network; the full nodes of the consortium blockchain energy trading network verify information of a new light node according to a preset condition in a smart contract; an electricity market trading entity that passes the verification joins the consortium blockchain energy trading network, and obtains a specific ID as a unique identification.

In the foregoing electricity market trading method based on a weak centralized consortium blockchain, implementation of consensus communication by the delegated byzantine fault tolerance consensus mechanism includes: first selecting a bookkeeping node according to node rights, and then achieving consensus through a byzantine fault tolerance algorithm.

In the foregoing electricity market trading method based on a weak centralized consortium blockchain, where through corresponding modeling of two major indicators of invulnerability and survivability, reliability of the consortium blockchain energy trading network in an electricity trading market is quantified by a quantitative calculation method; specific steps are as follows:

calculating a comprehensive invulnerability indicator according to a structure, nodes, and links of the consortium blockchain energy trading network, with calculation formula (1) shown as follows:

$${I}_{i} = 1 - {\prod }_{j = 1}^{{I}_{i}} ( 1 - {r}_{ij} {r}_{i}^{2} ) \qquad ( 1 )$$

where lᵢ denotes the number of available communication links connected to a node i; rᵢⱼ denotes communication reliability of the j^{th} available communication link connected to the node i, and r denotes communication reliability of the node i;

calculating, according to the comprehensive invulnerability indicator, an average node invulnerability indicator Iₜₒₜₐₗ of the consortium blockchain energy trading network composed of N nodes, with calculation formula (2) shown as follows:

$${I}_{t o t a l} = \frac{1}{N} {\sum }_{i = 1}^{N} {I}_{i} \qquad ( 2 )$$

where Iᵢ denotes comprehensive invulnerability of the node i;

calculating asurvivability index of the consortium blockchain energy trading network, with calculation formula (3) shown as follows:

the survivability index is used to measure a connectivity ability of remaining network nodes and communication links to reorganize network topology after soundness of the communication network is destroyed, and reflects survivability of the nodes and circuitous characteristics of the links;

$${S}_{i} = {p}_{i} {\sum }_{m = 1}^{t} {P}_{im} \frac{{l}_{im}}{{n}_{im} ( N - 1 )} \qquad ( 3 )$$

where t denotes a communication hop distance, pᵢ denotes communication reliability of the node i, Pᵢₘ denotes survivability of the node i in a hop plane m, which is equal to a product Pᵢₘ=pⁿ^{ᵢₘ} of communication reliability of all nodes in the hop plane, nᵢₘ denotes the number of nodes in the m^{th} hop plane of the node i, and lᵢₘ denotes the number of communication links connected between the node i and other nodes in the m^{th} hop plane;

calculating a system survivability indicator of the consortium blockchain energy trading network according to the survivability indicator, with calculation formulas (4) and (5) shown as follows:

for the N-node consortium blockchain energy trading network, the system survivability indicator Sₜₒₜₐₗ is expressed in a weighted manner:

$$\begin{matrix}{S}_{t o t a l} = \frac{1}{N} {\sum }_{i = 1}^{N} {α}_{i} {S}_{i} & ( 4 ) \\ {α}_{i} = \frac{{d}_{i}}{max ( {d}_{1} , {d}_{2} , … , {d}_{N} )} & ( 5 )\end{matrix}$$

where αᵢ denotes a survivability weighting factor of the node i; dᵢ is the number of nodes within a certain number of hops from the node i.

The present disclosure has the following beneficial effects: the underlying P2P network of the architecture satisfies the exchange of resources and services between various market entities, and adapts to the distribution characteristics of the electricity trading market; based on the byzantine fault tolerance consensus communication technology, the invulnerability and survivability indicators are established, and the reliability of the weak centralized blockchain technology in the electricity trading market is measured quantitatively.

The present disclosure adapts to the electricity trading management involving a large amount of diversified trading data of the continuously distributed power trading, and weakens the scheduling role of the grid in the electricity market trading by the consortium blockchain technology, and realize equal rights and responsibilities, transparent mutual trust, and intelligent autonomy between production and consumption users participating in the electricity trading; with the transformation based on the consortium blockchain technology, the invulnerability and survivability of electricity market trading are calculated quantitatively, thereby reducing the calculation and solution complexity of the quantitative analysis of communication reliability, and ensuring the reliability of the electricity market trading after improvement by the weak centralized consortium blockchain technology.

### BRIEF DESCRIPTION OF THE DRAWINGS

FIG. 1 shows an electricity market trading architecture using a weak centralized consortium blockchain technology according to an embodiment of the present disclosure;

FIG. 2 shows a blockchain information according to an embodiment of the present disclosure;

FIG. 3 shows a consortium blockchain energy trading network according to an embodiment of the present disclosure;

FIG. 4 shows an electricity trading market access architecture using a weak centralized consortium blockchain technology according to an embodiment of the present disclosure; and

FIG. 5 is a schematic diagram of a byzantine fault tolerance consensus communication according to an embodiment of the present disclosure.

### DETAILED DESCRIPTION

The implementations of the present disclosure are described below with reference to the accompanying drawings.

This embodiment uses a blockchain technology to weaken the centralization of an electricity market trading mode, and analyzes and selects among three major blockchain technologies: public blockchain, private blockchain, and consortium blockchain. Considering that the intelligent level of the power grid is not enough to achieve complete decentralization, the balance of supply and demand in the process of power generation, transmission and transformation, and power distribution is achieved through off-grid deployment. A consortium blockchain technology framework with a degree of weak centralization between the public blockchain and the private blockchain is selected, which is more suitable for scenarios of collaboration between different organizations in the electricity trading process. Consensus nodes of the consortium blockchain are responsible for permission control and bookkeeping, while offline rules restrict behaviors of participants.

In this embodiment, through the consortium blockchain, a P2P network, and a delegated byzantine fault tolerance consensus mechanism, electricity market operating organizations and electricity market trading entities are classified into a full-node network and a light-node network respectively; central control authority of the market operating organization is partially liberated by introducing the consortium blockchain technology and using a weak centralization characteristic thereof; the underlying P2P network of the architecture satisfies the exchange of resources and services between various market entities, and adapts to the distribution characteristics of the electricity trading market; based on the byzantine fault tolerance consensus communication technology, invulnerability and survivability indicators are established, and the reliability of the weak centralized blockchain technology in the electricity trading market is measured quantitatively.

This embodiment is implemented by the following technical solution: an electricity market trading method based on a weak centralized consortium blockchain, where electricity market operating organizations and electricity market trading entities are classified into a full-node network and a light-node network respectively. Full nodes store all structured contract basic data and trading data starting from a genesis block, and protect user privacy and confidential information of trading through hash mapping; the electricity market trading entities act as light nodes in a consortium blockchain energy trading network, and participate in an electricity trading process through a certain access mechanism; the light nodes, which are scalable and account for a major node proportion, are used to save contract-related trading hash values and trading data with adjacent timestamps that is necessary for brief payment verification, and can upload and download related data from the full nodes.

A peer-to-peer (P2P) network is introduced in a bottom layer of a communication architecture, while a central server of a conventional client/server (C/S) mode is removed. CPU computing resource sharing, disk storage sharing and information exchange are realized among nodes of the P2P network.

Moreover, based on a consortium blockchain system, node consensus is achieved by using a delegated byzantine fault tolerance (dBFT) consensus mechanism. A bookkeeping node is first selected according to node rights, and then consensus is achieved through a byzantine fault tolerance algorithm.

Moreover, two communication reliability performance indicators: invulnerability and survivability, are modeled, and indicator results are quantitatively calculated to reflect the reliability of electricity market trading: the invulnerability is analyzed comprehensively from the perspectives of certainty and randomness, and the complexity of calculation and solution is greatly reduced while the impact of the network structure, nodes and links is considered; based on the case of random failure of nodes and reliable links, the survivability indicator of the communication network is established to reflect the ability of reorganization and recovery after the communication network fails partially.

In specific implementation, as shown in FIG. 1, the electricity market trading architecture using the weak centralized consortium blockchain technology includes various types of power generation plants, electricity retailing (including electricity distribution and retailing) companies, power grid enterprises, electricity users, independent auxiliary service providers and other market entities, as well as market operating organizations such as an electricity trading center and an electricity scheduling organization. A blockchain-technology-based electricity trading management system provides an electric energy trading platform for electricity market trading entities, realizes matching, verification, settlement, value transfer, distributed storage and other functions of electricity trading, and makes information in competitive gaming in a multi-entity electricity market open and transparent. An electricity trading supervision policy, in the form of a blockchain smart contract or the like, strictly supervises the electricity trading process. The electricity trading market entity is in a physical layer, and an information system in a virtual layer formulates an electricity trading market mechanism and a pricing mechanism.

The electricity market trading entities participate in the electricity trading process through a certain access mechanism, and act as light nodes in the consortium blockchain energy trading network, which are scalable and account for a major node proportion, and save contract-related trading hash values and trading data with adjacent timestamps that is necessary for brief payment verification.

The electricity trading operating organizations are equivalent to full nodes, the number of full nodes is small, and each full node stores all the structured contract basic data and trading data starting from the genesis block.

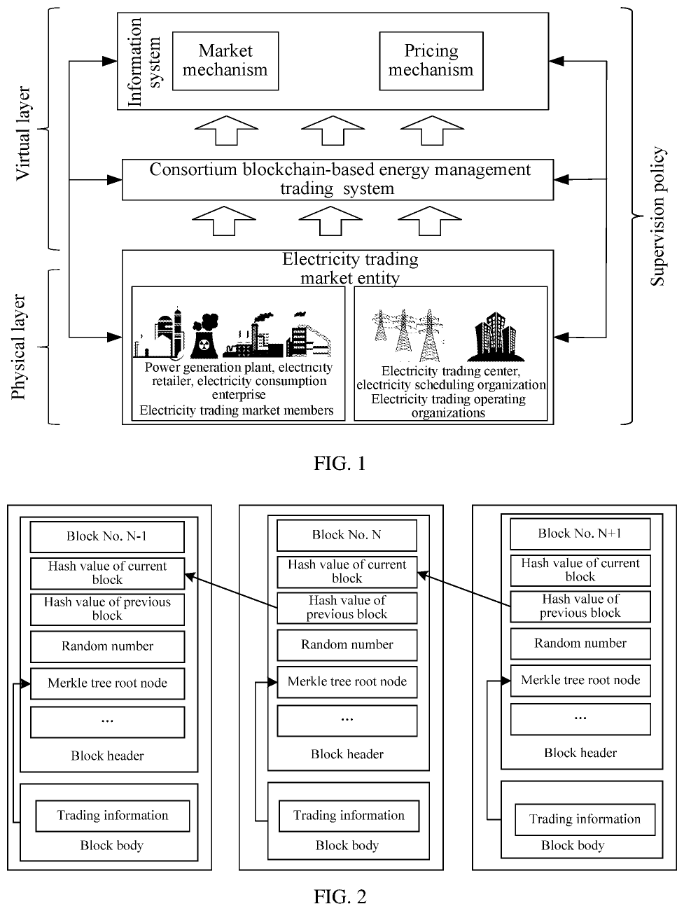

FIG. 2 shows an information interaction manner of blocks in the consortium blockchain technology according to this embodiment. The block specifically includes a block header and a block body: the block header includes a hash value of a previous block header, a random number, a Merkle root, etc. The block body records verified trading information. After hash operation, such trading information is connected to the block header by a data structure of a Merkle tree, which can easily and quickly verify the integrity of the block data and ensure that the information is not maliciously tampered with and spread.

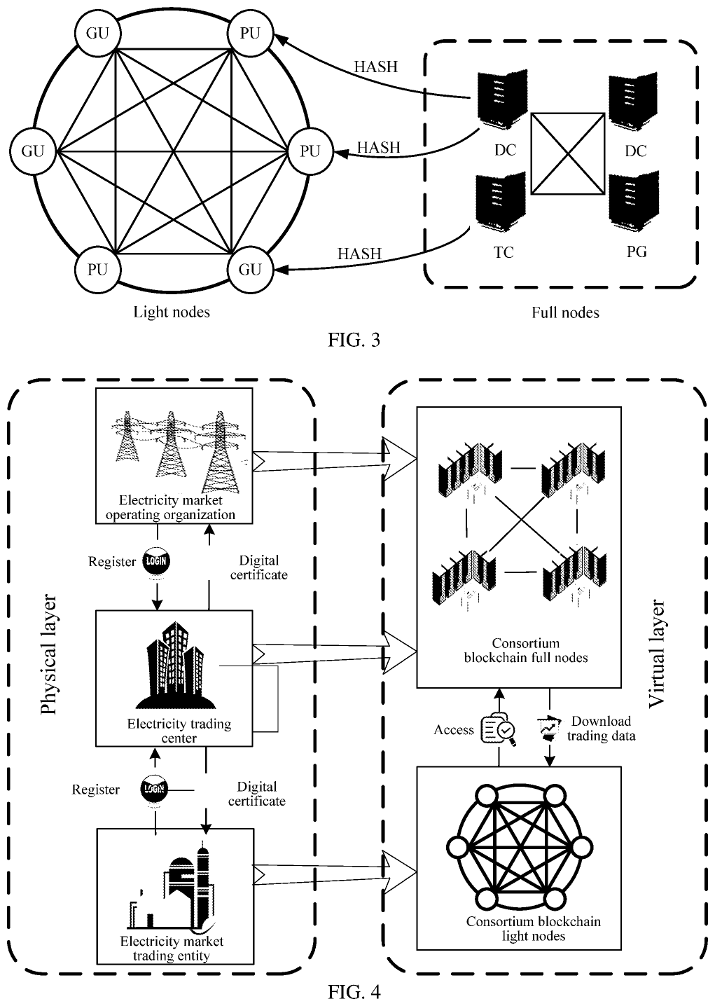

As shown in FIG. 3, the relationship between the full nodes and the light nodes in the weak centralized consortium blockchain technology according to this embodiment is as follows: the light nodes can upload and download related data from the full nodes. The full nodes protect user privacy and confidential information of trading through hash mapping, which ensures tamper resistance of the data. This not only preserves the storage capacity of the ledger and improves processing performance, but also greatly reduces the storage burden of the system. The power trading consortium blockchain retains a centralized database, and establishes a “weak-centralized” distributed electricity trading communication mechanism in a broad sense, which not only helps to improve the consensus efficiency on the chain, but also facilitates centralized operations such as query, statistics and auditing.

As shown in FIG. 4, in the access management process of the trading network in the weak centralized consortium blockchain technology according to this embodiment, the electricity trading center acts as a supervisor, and only electricity market trading entities that comply with the market access mechanism can join the electricity trading consortium blockchain. The electricity market trading entity submits related information, such as an identity (ID), a geographic location, an energy type, power generation characteristics, etc., to the electricity trading center, and the related information is broadcast to the whole network through the consortium blockchain energy trading network. The full nodes of the consortium blockchain verify information of a new light node according to a preset condition in a smart contract. An electricity trading market that passes the verification can join the consortium blockchain energy trading network and obtain a specific ID as a unique identification.

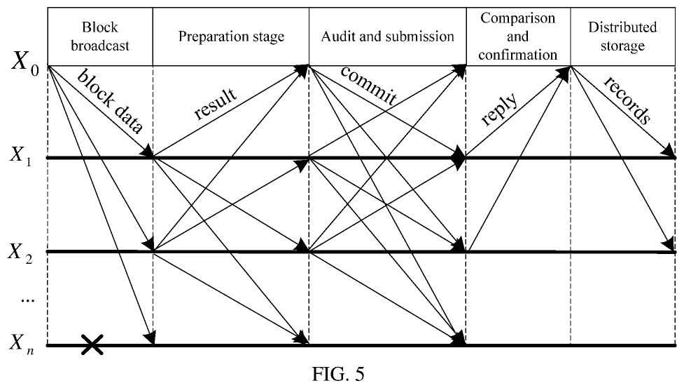

As shown in FIG. 5, in the weak centralized consortium blockchain technology of this embodiment, a delegated byzantine fault tolerance algorithm is used to implement the consensus communication process. It is assumed that a full node x₀ with a higher node right in the consortium blockchain is selected as a “temporary” communication master node in a certain consensus cycle, and the remaining full nodes in the consortium block are communication slave nodes, which are recorded as X₁, X₂, . . . , Xₙ; the forked node Xₙ indicates that the node is a problematic node, which is unresponsive to requests of other nodes. A successful algorithmic consensus includes: the temporary communication master node X₀ of the consortium blockchain collects electricity trading information across the network, consolidates the information into a to-be-verified block (block data), attaches a digital signature of the current node and a block hash value to the block data, and broadcasts the block data to the whole network; after receiving a list of trading, each node executes the trading based on block content, calculates a hash digest of the new block based on trading results, generates a digital signature for a block audit result by a private key, and broadcasts the digital signature to the whole network; if a node receives, from more than 2f (f is the number of tolerable byzantine nodes) within a certain period of time, audit information that is equal to its own audit information, the node broadcasts a piece of authentication information (commit) to the whole network; if a node receives a total of 2f+1 pieces of authentication information (including its own authentication information), it means that a consensus has been reached, and reply information (reply) may be submitted to the temporary communication master node X₀; the communication master node X₀ consolidates the block together with certificates of other nodes that participate in the audit as well as the corresponding digital signatures into records, broadcasts the records, and stores the block into the consortium blockchain.

To ensure the reliability of the weak centralized blockchain technology, a reliability evaluation method for electricity market trading based on a weak centralized consortium blockchain is used, which includes: correspondingly modeling two major indicators of invulnerability and survivability, and quantifying reliability of the weak centralized blockchain technology in an electricity trading market by a quantitative calculation method.

Formula (1) is a comprehensive invulnerability indicator, which takes impact of a network structure, nodes and links into consideration while solving the problems that complex conditional probabilities need to be calculated in randomness measurement of the invulnerability, complex factors need to be considered, and a solution process is complex:

$${I}_{i} = 1 - {\prod }_{j = 1}^{{I}_{i}} ( 1 - {r}_{ij} {r}_{i}^{2} ) \qquad ( 1 )$$

where Iᵢ denotes the number of available communication links connected to a node i; rᵢⱼ denotes communication reliability of the j^{th} available communication link connected to the node i; and rᵢ denotes communication reliability of the node i.

An average node invulnerability indicator Iₜₒₜₐₗ in a communication network composed of N nodes is expressed as:

$${I}_{t o t a l} = \frac{1}{N} {\sum }_{i = 1}^{N} {I}_{i} \qquad ( 2 )$$

where Iᵢ denotes comprehensive invulnerability of the node i.

The survivability indicator shown in formula (3) is used to measure a connectivity ability of remaining network nodes and communication links to reorganize network topology after soundness of the communication network is destroyed, and reflects survivability of the nodes and circuitous characteristics of the links.

$${S}_{i} = {p}_{i} {\sum }_{m = 1}^{t} {P}_{im} \frac{{l}_{im}}{{n}_{im} ( N - 1 )} \qquad ( 3 )$$

where t denotes a communication hop distance; pᵢ denotes communication reliability of the node i; Pᵢₘ denotes survivability of the node i in a hop plane m, which is equal to a product (Pᵢₘ=pⁿ^{ᵢₘ}) of communication reliability of all nodes in the hop plane; nᵢₘ denotes the number of nodes in the m^{th} hop plane of the node i; and lᵢₘ denotes the number of communication links connected between the node i and other nodes in the m^{th} hop plane.

For an N-node electricity trading communication network, a system survivability indicator Sₜₒₜₐₗ is expressed in a weighted manner:

$$\begin{matrix}{S}_{t o t a l} = \frac{1}{N} {\sum }_{i = 1}^{N} {α}_{i} {S}_{i} & ( 4 ) \\ {α}_{i} = \frac{{d}_{i}}{max ( {d}_{1} , {d}_{2} , … , {d}_{N} )} & ( 5 )\end{matrix}$$

where αᵢ denotes a survivability weighting factor of the node i; dᵢ is the number of nodes within a certain number of hops from the node i.

It should be noted that, all content not described in detail in the specification belongs to the prior art.

Although the implementations of the present disclosure are described above with reference to the accompanying drawings, a person of ordinary skill in the art should understand that such implementations are merely examples for description, various variations or modifications may be made on the implementations without departing from the principle and essence of the present disclosure. The scope of the present disclosure is defined by the appended claims.

1. An electricity market trading method based on a weak centralized consortium blockchain, wherein through the consortium blockchain, a peer-to-peer (P2P) network, and a delegated byzantine fault tolerance consensus mechanism, electricity market operating organizations and electricity market trading entities are classified into a full-node network and a light-node network respectively; the electricity market operating organizations are equivalent to full nodes, wherein the full nodes store all structured contract basic data and trading data starting from a genesis block, and protect user privacy and confidential information of trading through hash mapping;
the electricity market trading entities act as light nodes in a consortium blockchain energy trading network, and participate in an electricity trading process through a certain access mechanism; the light nodes, which are scalable and account for a major node proportion, are used to save contract-related trading hash values and trading data with adjacent timestamps that is necessary for brief payment verification, and can upload and download data from the full nodes.

2. The electricity market trading method based on a weak centralized consortium blockchain according to claim 1, wherein consensus nodes of the consortium blockchain energy trading network are responsible for permission control and bookkeeping, while offline rules restrict behaviors of participants.

3. The electricity market trading method based on a weak centralized consortium blockchain according to claim 1, wherein the P2P network is introduced in a bottom layer of a communication architecture of the consortium blockchain energy trading network, while a central server of a conventional client/server (C/S) mode is removed; and central processing unit (CPU) computing resource sharing, disk storage sharing and information exchange are realized among nodes of the P2P network.

4. The electricity market trading method based on a weak centralized consortium blockchain according to claim 1, wherein the electricity market operating organizations comprise an electricity trading center and an electricity scheduling organization; the electricity market trading entities comprise a power generation plant, an electricity retailer, a power grid enterprise, an electricity user, and an independent auxiliary service provider.

5. The electricity market trading method based on a weak centralized consortium blockchain according to claim 4, wherein the access mechanism of the electricity market trading entity comprises: the electricity market trading entity submits an identity (ID), a geographic location, an energy type, and electricity generation feature information to the electricity trading center, and the ID, the geographic location, the energy type, and the electricity generation feature information are broadcast to the entire network through the consortium blockchain energy trading network; the full nodes of the consortium blockchain energy trading network verify information of a new light node according to a preset condition in a smart contract; an electricity market trading entity that passes the verification joins the consortium blockchain energy trading network, and obtains a specific ID as a unique identification.

6. The electricity market trading method based on a weak centralized consortium blockchain according to claim 1, wherein implementation of consensus communication by the delegated byzantine fault tolerance consensus mechanism comprises: first selecting a bookkeeping node according to node rights, and then achieving consensus through a byzantine fault tolerance algorithm.

7. The electricity market trading method based on a weak centralized consortium blockchain according to claim 1, wherein through corresponding modeling of two major indicators of invulnerability and survivability, reliability of the consortium blockchain energy trading network in an electricity trading market is quantified by a quantitative calculation method; specific steps are as follows:
calculating a comprehensive invulnerability indicator according to a structure, nodes, and links of the consortium blockchain energy trading network, with a calculation formula (1) shown as follows:
$${I}_{i} = 1 - {\prod }_{j = 1}^{{I}_{i}} ( 1 - {r}_{ij} {r}_{i}^{2} ) \qquad ( 1 )$$
wherein lᵢ denotes the number of available communication links connected to a node i; rᵢⱼ denotes communication reliability of the j^{th} available communication link connected to the node i, and rᵢ denotes communication reliability of the node i;
calculating, according to the comprehensive invulnerability indicator, an average node invulnerability indicator Iₜₒₜₐₗ of the consortium blockchain energy trading network composed of N nodes, with a calculation formula (2) shown as follows:
$${I}_{t o t a l} = \frac{1}{N} {\sum }_{i = 1}^{N} {I}_{i} \qquad ( 2 )$$
wherein Iᵢ denotes comprehensive invulnerability of the node i;
calculating a survivability index of the consortium blockchain energy trading network, with calculation formula (3) shown as follows:
wherein the survivability index is used to measure a connectivity ability of remaining network nodes and communication links to reorganize network topology after soundness of the communication network is destroyed, and reflects survivability of the nodes and circuitous characteristics of the links;
$${S}_{i} = {p}_{i} {\sum }_{m = 1}^{t} {P}_{im} \frac{{l}_{im}}{{n}_{im} ( N - 1 )} \qquad ( 3 )$$
wherein t denotes a communication hop distance, pᵢ denotes communication reliability of the node i, Pᵢₘ denotes survivability of the node i in a hop plane m, which is equal to a product Pᵢₘ=pⁿ^{ᵢₘ} of communication reliability of all nodes in the hop plane, nᵢₘ denotes the number of nodes in the m^{th} hop plane of the node i, and lᵢₘ denotes the number of communication links connected between the node i and other nodes in the m^{th} hop plane;
calculating a system survivability indicator of the consortium blockchain energy trading network according to the survivability indicator, with calculation formulas (4) and (5) shown as follows:
for the N-node consortium blockchain energy trading network, the system survivability indicator Sₜₒₜₐₗ is expressed in a weighted manner:
$$\begin{matrix}{S}_{t o t a l} = \frac{1}{N} {\sum }_{i = 1}^{N} {α}_{i} {S}_{i} & ( 4 ) \\ {α}_{i} = \frac{{d}_{i}}{max ( {d}_{1} , {d}_{2} , … , {d}_{N} )} & ( 5 )\end{matrix}$$
wherein αᵢ denotes a survivability weighting factor of the node i; dᵢ is the number of nodes within a certain number of hops from the node i.
